(19) United States
(12) Patent Application Publication
(10) Pub. No.: US 2002/0073930 A1
(43) Pub. Date: Jun. 20, 2002

(54) PET GROOMING TOOL

(75) Inventor: Patrick S. Y. Kan, Kowloon (HK)

Correspondence Address: ALLAN M. SHAPIRO, Suite 202, 18401 Burbank Boulevard, Tarzana, CA, 91356-2824, US

(73) Assignee: TOPET (H.K.) CO., LIMITED

(21) Appl. No.: 09/739,313

(22) Filed: Dec. 19, 2000

(51) Int. Cl. A01K 13/00

(52) U.S. Cl. 119/631

(57) ABSTRACT

The pet grooming tool comprises a body sized to be held in the hand. The body has an opening in its underside. Within the body is mounted a rocking grooming tool holder which rocks within the body to follow the general contours of the animal as the grooming tool is manually moved over the coat of a pet animal to be groomed. Springs resiliently center the grooming tool holder in the body.

### FIELD OF THE INVENTION

This invention is directed to a pet grooming tool in the form of a hand-held body which has tools therein on a rocking tool holder. The tools may be combs, shedding blades, and other or similar tools for grooming the coat or fur of a pet animal. The rocking tool holder is within the body which can be grasped to run the tools in the tool holder over the fur of an animal. The grooming tool is preferably sized to be grasped by the fingers and held in the palm of the hand for grooming of a pet such as a cat or dog.

### BACKGROUND OF THE INVENTION

Furry animals, and particularly dogs and cats, require grooming in order to maintain their coats in best condition. For simplicity and convenience, the terms “combing” and “grooming” will be used usually interchangeably, although other both general and specific grooming terms are intended to be included. The combing of the coat removes loose hair. The combing also removes snarls. It combs out foreign materials such as burrs and soil. Thorough grooming also gives pleasure to the animal and his owner. The well-groomed coat is a thing to admire.

A serviceable pet grooming tool which is convenient to handle and does a fine grooming job is essential to proper grooming. The grooming tool must be able to be manually handled and it must be designed and configured to accomplish proper grooming.

### SUMMARY OF THE INVENTION

In order to aid in the understanding of this invention it can be stated in essentially summary form that it is directed to a pet grooming tool having a body which can be grasped in the hand. A tool holder retains grooming tools and is rockably mounted in the body so that the tools follow the contour of the animal being groomed without rocking the hand.

It is thus a purpose and advantage of this invention to provide a pet grooming tool which can be grasped in the hand for moving over the animal's body for the grooming of its coat, wherein the grooming tools are rockably mounted in the body to follow the contours of the animal's body as the pet grooming tool passes thereover.

It is another purpose and advantage of this invention to provide a pet grooming tool which is particularly useful for dogs and has a plurality of combs or other tools therein mounted in a rocking tool holder which is mounted to rock in the body of the hand-held tool.

It is another purpose and advantage of this invention to provide an animal grooming tool which is easy to use and provides an optimum condition for grooming because the grooming tools are rockably mounted within the body.

The features of this invention which are believed to be novel are set forth with particularity in the appended claims. The present invention, both as to its organization and manner of operation, together with further objects and advantages thereof, may be best understood by reference to the following description, taken in conjunction with the accompanying drawings.

### BRIEF DESCRIPTION OF THE DRAWINGS

FIG. 1 is a perspective view of the pet grooming tool of this invention, as seen from the bottom, front and left side.

FIG. 2 is an exploded perspective view of the pet grooming tool as seen from the top, front, and left side.

FIG. 3 is an exploded sectional view of the pet grooming tool taken in the direction of the arrows along line 3-3 in FIG. 1, partly in elevation.

FIG. 4 is a top plan view of the pet grooming tool, partly broken away to show the top of the rocking tool holder and its mounting.

FIG. 5 is a left side elevational view of the pet grooming tool, partly broken away and partly in longitudinal section.

FIG. 6 is a rear end elevational view, partly broken away and partly in transverse section.

### DESCRIPTION OF THE PREFERRED EMBODIMENT

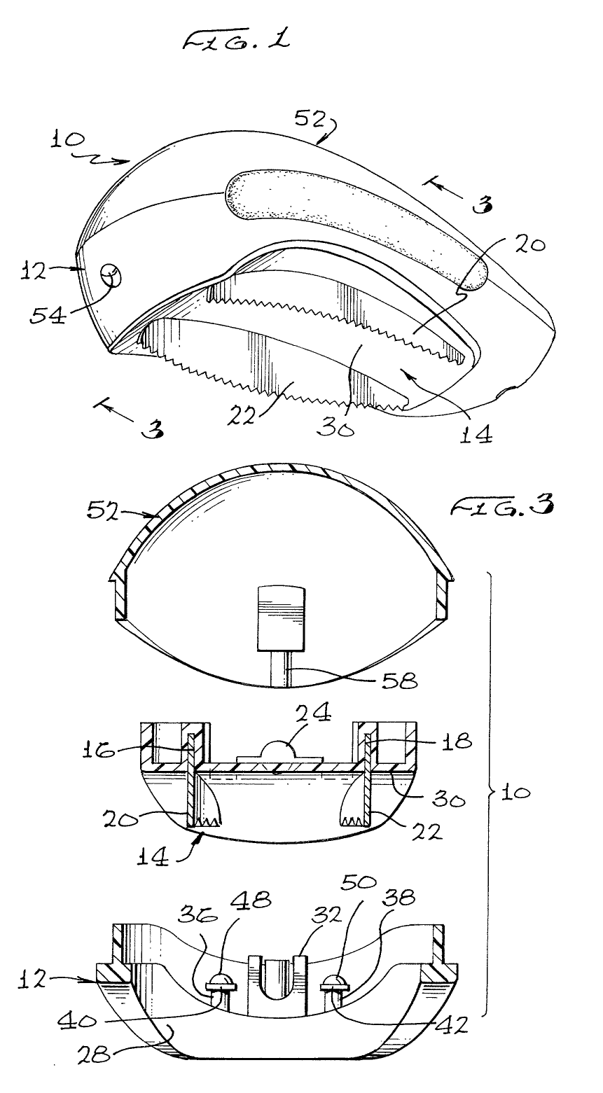

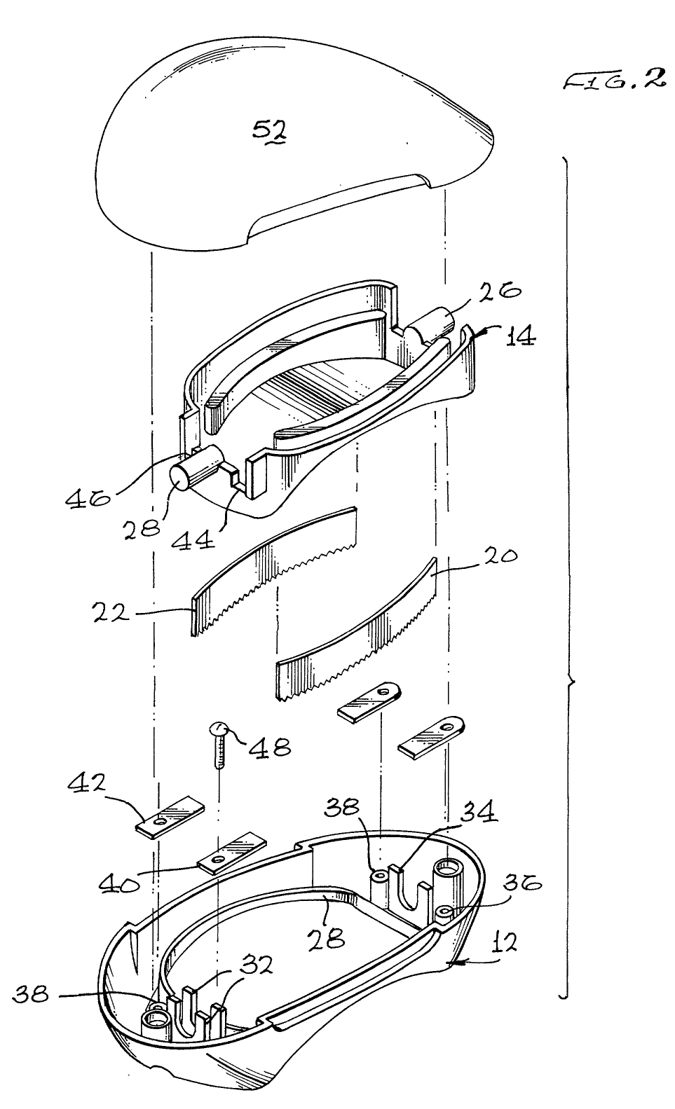

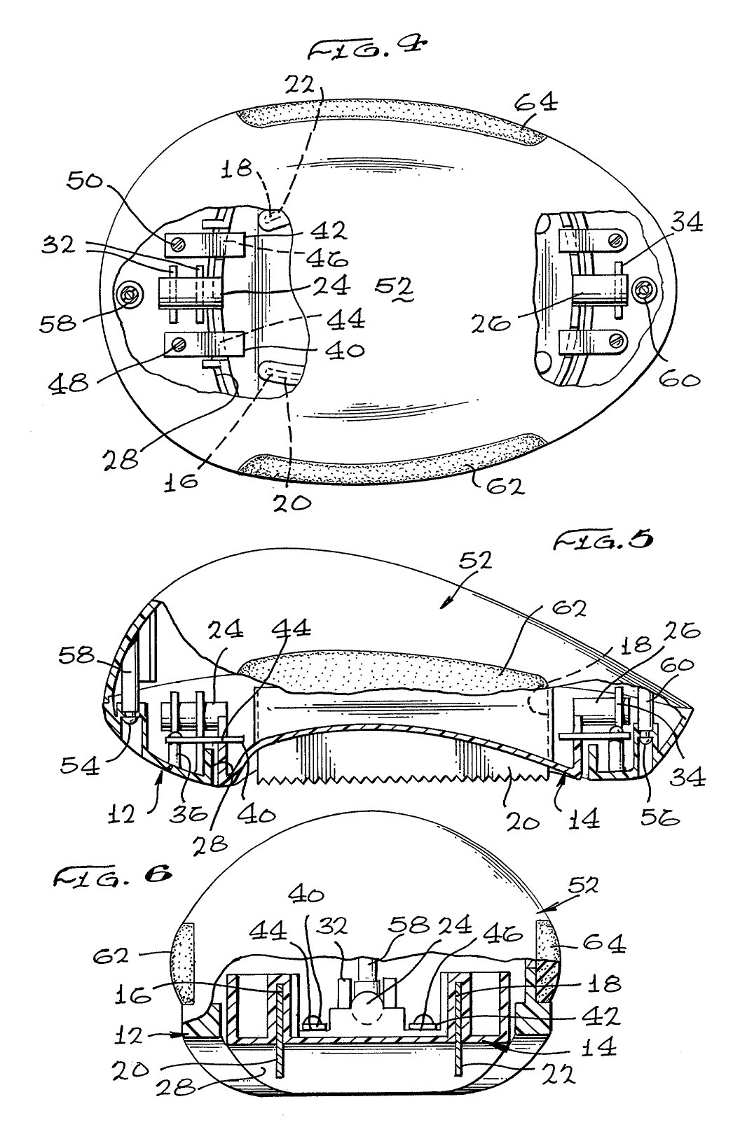

The pet grooming tool of this invention has a body generally indicated at 10 in FIG. 1. The body has a base 12 in which is mounted rocking tool holder 14. The rocking tool holder 14 has two slots 16 and 18, which are oriented in the vertical direction as seen in FIGS. 2, 3 and 6. The comb slots are slightly curved. Combs or shedding blades 20 and 22 are stainless steel rectangular sheet stock with comb teeth formed on the active lower edge, as seen in FIGS. 1, 3 and 5. These combs are flat in the nonstressed condition and are resiliently bent to fit up into the comb slots 16 and 18. This spring action prevents the combs from falling out of the comb slots.

Trunions 24 and 26 are integrally formed on the ends of rocking tool holder 14. They define the rocking axis of the tool holder 14.

Base 12 has an opening 28 through which the combs extend and which exposes the bottom 30 of the comb holder. A pair of yokes 32 is positioned on the base 12 adjacent the opening 28 at the front end of base 12 and a similar pair of yokes 34 is positioned adjacent the rear end of the opening 28. These pairs of yokes respectively receive trunions 24 and 26. The trunions permit rocking of the rocking tool holder 14 within the base 12.

Base 12 has mounts 36 and 38 therein, one on each side of the front yokes 32. Springs 40 and 42 are mounted on the mounts and engage over shoulders 44 and 46 on the rocking tool holder. Springs 40 and 42 are respectively held in place by screws 48 and 50 which engage through holes in the springs and into holes in the mounts 36 and 38. The rear trunion 26 is similarly biased at the rear end. The springs are light to permit rocking of the comb holder but are strong enough to recenter the comb holder in the base 12 when there is no rocking force on the comb holder.

Cover 52 has an interior recess which receives the rocking comb holder 14 and the structure thereon. The cover is held on the base by means of screws 54 and 56 which extend upward through suitable openings in the base 12 and engage in screw stanchions 58 and 60 extending downwardly within cover 52.

Cover 52 is sized to fit within the palm of the hand. A pair of finger grips 62 and 64 are secured on opposite sides of the cover 52, and may be rubber or other material for frictional engagement.

The pet grooming tool 10 is grasped in the hand with the thumb overlying one of the side grips 62 or 64 on the cover. The combs 20 and 22 are generally aligned with the hand and thus are oriented in a manner such that normal sideward motion of the hand causes the combs to stroke the animal coat. The direction of motion of the grooming tool 10 is thus easily achieved by elbow action. The grooming tool is applied to the coat to comb the coat in the direction of natural growth.

As mentioned before, the combs described herein may be replaced with any convenient and desired grooming tools for achieving any desired effects.

This invention has been described in its presently contemplated best mode and it is clear that it is susceptible to numerous modifications, modes and embodiments within the ability of those skilled in the art and without the exercise of the inventive faculty. Accordingly, the scope of this invention is defined by the scope of the following claims.

What is claimed is:

1. A pet grooming tool comprising:
a body configured to be held in the hand;
a rocking tool holder pivotally mounted in said hand-held body, said rocking tool holder having at least one grooming tool therein, said grooming tool having a grooming edge extending outwardly and downwardly from said rocking tool holder to be accessible for grooming so that, as said body is hand held and said grooming tool is engaged with and passed over the coat of a furry animal, said grooming tool grooms the fur and said rocking tool holder pivotally rocks to the configuration of the animal without rocking of said hand-held body.

2. The pet grooming tool of claim 1 wherein said tool holder carries a plurality of tools.

3. The pet grooming tool of claim 2 wherein said tool holder has a plurality of slots therein, one of said tools being disposed in each of said slots, each of said tools having an active edge, said active edges of said tools extending out of said tool holder and said body.

4. The pet grooming tool of claim 3 wherein each of said tool slots has a curved shape, and each of said tools is straight in the unstressed position, said tools being metallic and being stressed into said curved shape when in said tool slots.

5. The pet grooming tool of claim 2 wherein each of said tool slots has a curved shape, and each of said tools is straight in the unstressed position, said tools being metallic and being stressed into said curved shape when in said tool slots.

6. The pet grooming tool of claim 1 including a base, said base having pivotal structure therein, and said rocking tool holder having pivotal structure therein engaging in said pivotal structure in said base so that said tool holder pivots within said base.

7. The pet grooming tool of claim 6 wherein said pivotal structure comprises first and second yokes in said base and first and second trunions on said rocking tool holder, said trunions engaging in said yokes so that said rocking tool holder is pivotable in said base.

8. The pet grooming tool of claim 6 wherein there is at least one spring interengaged between said base and said rocking tool holder to resiliently retain said rocking tool holder in a substantially central position. central position.

9. The pet grooming tool of claim 8 wherein said spring comprises first and second leaf springs mounted on said base and there are shoulders on said rocking tool holder, said springs engaging upon said shoulders to resiliently retain said rocking tool holder in a substantially central position with respect to said base.

10. The pet grooming tool of claim 1 comprising a base to support said rocking tool holder and permit rocking motion thereof, and a cover attached to said base and covering said rocking tool holder, said cover being configured to be hand held.

11. The pet grooming tool of claim 10 including a pair of finger grips on said cover, said grips being positioned on opposite longitudinal edges of said cover.

12. A pet grooming tool comprising:
a body, said body including a base having an opening therein;
said body including a cover configured to engage over said base, said base and said cover being sized and configured to be engaged in the hand of the groomer;
a grooming tool holder in said base, said grooming tool holder having at least one grooming tool therein, said grooming tool having an active edge positioned to extend out of said opening in said base; and
a pivotal structure interengaged between said grooming tool holder and said base to permit rocking motion of said grooming tool holder and said grooming tool in said body when the groomer passes said grooming tool over the coat of an animal being groomed.

13. The pet grooming tool of claim 12 wherein said tool holder has a plurality of slots therein and there is a grooming tool retained in each of said slots.

14. The pet grooming tool of claim 13 wherein said pivotal structure comprises a pivotal mechanism at each end of said rocking grooming tool holder, said pivotal mechanism comprising a trunion engaging in a yoke to define a rocking axis of said grooming tool holder with respect to said base, with said rocking axis substantially parallel to the manual engagement of said body.

15. The pet grooming tool of claim 14 wherein there is at least one spring interengaged between said grooming tool holder and said body to resiliently urge said grooming tool holder to a central position with respect to said body.

16. The pet grooming tool of claim 15 wherein said spring comprises a leaf spring.
